(19) United States
(12) Patent Application Publication
(10) Pub. No.: US 2010/0118457 A1
(43) Pub. Date: May 13, 2010

(54) ELECTROSTATIC DISCHARGE PROTECTION CIRCUIT

(76) Inventor: Kook-Whee KWAK, Gyeonggi-do (KR)

Correspondence Address: IP & T Law Firm PLC, 7700 Little River Turnpike, Suite 207, Annandale, VA, 22003, US

(21) Appl. No.: 12/613,406

(22) Filed: Nov. 5, 2009

(30) Foreign Application Priority Data
Nov. 10, 2008 (KR) 10-2008-0111249

(51) Int. Cl. H02H 9/00

(52) U.S. Cl. 361/56

(57) ABSTRACT

An electrostatic discharge protection circuit includes an electrostatic induction unit connected between a power supply line and a data input/output line of an input/output pad, and configured to induce static electricity introduced through the input/output pad to the power supply line; a coupling capacitor having a first terminal connected to the power supply line; and a silicon controlled rectifier (SCR) unit connected to a second terminal of the coupling capacitor, connected between the data input/output line and a ground voltage line, and configured to discharge the static electricity on the data input/output line to the ground voltage line by static electricity introduced through the coupling capacitor.

### CROSS-REFERENCE TO RELATED APPLICATIONS

The present application claims priority of Korean Patent Application No. 10-2008-111249, filed on Nov. 10, 2008, which is incorporated herein by reference in its entirety.

### BACKGROUND OF THE APPLICATION

Exemplary embodiments of the present invention relate to an electrostatic discharge protection circuit, and more particularly, to an electrostatic discharge protection circuit for protecting a semiconductor device from electrostatic discharge (ESD) by discharging static electricity introduced through an input/output pad of the semiconductor device.

In general, electrostatic discharge protection circuits for protecting internal circuits from static electricity introduced from the outside are provided at input/output pads of semiconductor devices.

Diodes, metal oxide semiconductor (MOS) transistors, and silicon controlled rectifiers (SCR) are widely used to configure electrostatic discharge protection circuits for semiconductor devices.

Semiconductor devices tend to use a lower operating voltage in order to achieve high integration density and low power consumption, and electrostatic discharge protection circuits are configured to be operable at a low trigger voltage in order to cope with such technical trends.

Therefore, a low voltage triggered SCR (LVTSCR) has been proposed for generating a low trigger voltage. The LVTSCR is configured by adding a coupling capacitor to a typical SCR.

Meanwhile, electrostatic discharge protection circuits must not act as components to affect normal operations of high-speed semiconductor devices.

As an example of a conventional electrostatic discharge protection circuit, an LVTSCR is disclosed in U.S. Pat. No. 6,768,616. The structure of the LVTSCR is illustrated in FIG. 1.

Referring to FIG. 1, the conventional electrostatic discharge protection circuit 100 includes an electrostatic discharge unit 120 at an input/output pad 110, and a coupling capacitor 125 between the input/output pad 110 and the electrostatic discharge unit 120.

The electrostatic discharge unit 120 includes a PNP transistor 121 and an NPN transistor 122. An emitter of the PNP transistor 121, a base of the NPN transistor 122, and a substrate resistor 123 are connected to the node 124 to which the coupling capacitor 125 is connected.

The electrostatic discharge unit 120 having the above-described structure performs an operation of discharging static electricity introduced through the input/output pad 110 toward a ground voltage line VSS by switching between the input/output pad 110 and the ground voltage line VSS with the use of the static electricity introduced through the coupling capacitor 125 as a detection current.

However, since the coupling capacitor 125 is connected to the input/output pad 110, a normal input/output operation of a high-speed semiconductor device may be affected.

For example, an internal signal of a 1-GHz semiconductor device generally has a signal rise time of approximately 100 ps.

If such a signal is applied to the input/output pad 110, a considerable leakage current is generated to a ground voltage line by impedance of the coupling capacitor 125, which may cause serious signal distortions.

Therefore, there is a need for an electrostatic discharge protection circuit for high-speed semiconductor device, which is capable of triggering an ESD operation at a low voltage but does not affect a normal operation of the semiconductor device.

### SUMMARY OF THE APPLICATION

An embodiment of the present invention is directed to providing an electrostatic discharge protection circuit adapted for a high-speed semiconductor device, which is operable at a low trigger voltage and prevents distortions of signals applied through an input/output pad, so that a normal operation of the semiconductor device is not affected.

In accordance with an embodiment of the present invention, an electrostatic discharge protection circuit includes an electrostatic induction unit connected between a power supply line and a data input/output line of an input/output pad, and configured to induce static electricity introduced through the input/output pad to the power supply line; a coupling capacitor having a first terminal connected to the power supply line; and a silicon controlled rectifier (SCR) unit connected to a second terminal of the coupling capacitor, connected between the data input/output line and a ground voltage line, and configured to discharge the static electricity on the data input/output line to the ground voltage line by static electricity introduced through the coupling capacitor.

The electrostatic induction unit may include an electrostatic discharge protection element configured to induce the static electricity in one direction.

The electrostatic discharge protection element may include any one of a diode, a metal-oxide-semiconductor (MOS) transistor, a bipolar junction transistor (BJT), and an SCR.

The SCR unit may include a first transistor configured to be turned on by a detection voltage generated by the static electricity introduced through the coupling capacitor; a substrate resistor configured to cause a voltage drop by the static electricity introduced through the coupling capacitor, a voltage generated by the voltage drop being applied to the first transistor as the detection voltage; and a second transistor configured to discharge the static electricity from the data input/output line to the ground voltage line when the first transistor is turned on.

The substrate resistor may belong to a discharge path of the second transistor.

The first transistor and the second transistor may include BJTs or MOS transistors.

In accordance with another embodiment of the present invention, an electrostatic discharge protection circuit includes an electrostatic induction unit connected between a power supply line and a data input/output line of an input/output pad, and configured to induce static electricity introduced through the input/output pad to the power supply line; a detection unit connected to the power supply line and comprising a coupling capacitor, the detection unit being configured to detect static electricity of the power supply line; and an electrostatic discharge unit connected between the data input/output line and the ground voltage line, connected to the detection unit, and configured to be driven by an output signal of the detection unit to discharge the static electricity of the data input/output line to the ground voltage line.

The electrostatic induction unit may include an electrostatic discharge protection element configured to induce the static electricity in one direction.

The electrostatic discharge protection element may include any one of a diode, a MOS transistor, a BJT, and an SCR.

The electrostatic discharge unit may include a first transistor configured to be turned on by a detection voltage generated by the static electricity introduced through the coupling capacitor; and a second transistor configured to discharge the static electricity of the data input/output line to the ground voltage line when the first transistor is turned on.

The detection unit may include the coupling capacitor and a resistor connected between the ground voltage line and the coupling capacitor.

The resistor may include a substrate resistor of the electrostatic discharge unit.

The first transistor may include one of a BJT and a MOS transistor.

The second transistor may include one of a BJT and a MOS transistor.

### BRIEF DESCRIPTION OF THE DRAWINGS

FIG. 1 is circuit diagram of a conventional electrostatic discharge protection circuit.

FIG. 2 is a block diagram of an electrostatic discharge protection circuit in accordance with a first embodiment of the present invention.

FIG. 3 is a block diagram of the electrostatic discharge protection circuit in accordance with the first embodiment of the present invention.

FIG. 4 is a block diagram of an electrostatic discharge protection circuit in accordance with a second embodiment of the present invention,

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments.

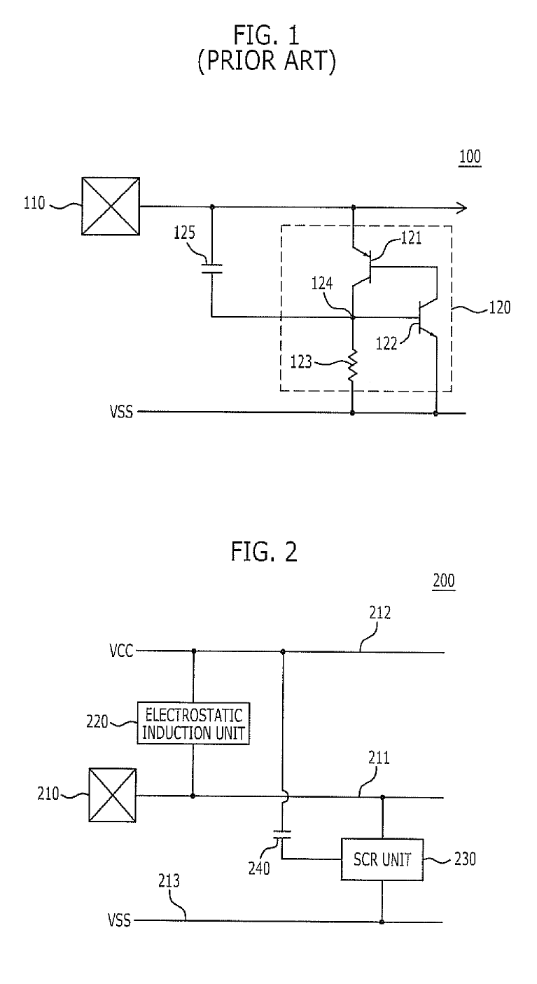

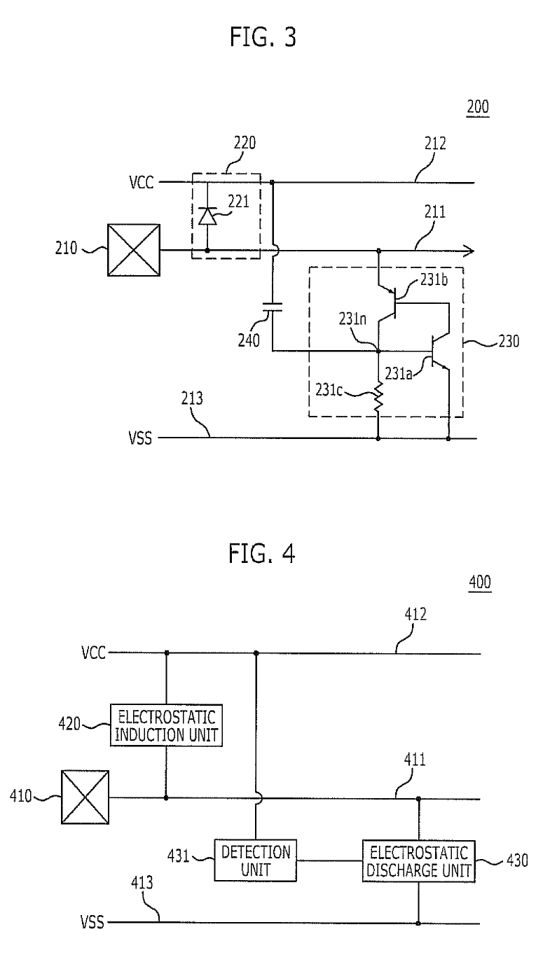

FIG. 2 is a block diagram of an electrostatic discharge protection circuit 200 in accordance with a first embodiment of the present invention, and FIG. 3 is a circuit diagram of the electrostatic discharge protection circuit 200 in accordance with the first embodiment of the present invention.

Referring to FIG. 2, the electrostatic discharge protection circuit 200 in accordance with the first embodiment of the present invention includes an electrostatic induction unit 220, an SCR unit 230, and a coupling capacitor 240.

The electrostatic induction unit 220 is connected between a data input/output line 211 of an input/output pad 210 and a power supply line 212 (VCC), and configured to induce static electricity introduced from the input/output pad 210 to the power supply line 212.

The coupling capacitor 240 has a first terminal connected to the power supply line 212 and a second terminal connected to the SCR unit 230.

The SCR unit 230 is connected to the second terminal of the coupling capacitor 240 and is also connected between the data input/output line 211 and a ground voltage line 213 (VSS). The SCR unit 230 is configured to discharge static electricity of the data input/output line 211 to the ground voltage line 213 by static electricity introduced through the coupling capacitor 240.

In this case, the coupling capacitor 240 may be designed with various capacitances, considering an operating speed of the semiconductor device. Generally, the capacitance of the coupling capacitor 240 may be in a range between approximately 1 pF to approximately 1 nF.

An operation of the electrostatic discharge protection circuit 200 illustrated in FIG. 2 will be described below.

If static electricity is introduced into the input/output pad 210, the electrostatic induction unit 220 induces the static electricity to the power supply line 212, and the static electricity induced to the power supply line 212 flows into the SCR unit 230 through the coupling capacitor 240.

The SCR unit 230 operates so the static electricity introduced from the input/output pad 210 to the data input/output line 211 is discharged to the ground voltage line 213.

A further detailed description will be made with reference to FIG. 3. The electrostatic induction unit 220 includes an electrostatic discharge protection element 221 having a first terminal connected to the data input/output line 211 of the input/output pad 210 and a second terminal connected to the power supply line 212. The electrostatic discharge protection element 221 induces the static electricity in one direction.

The electrostatic discharge protection element 221 may be configured by at least one of a diode, a metal oxide semiconductor field effect transistor (MOSFET), a bipolar junction transistor (BJT), and an SCR. A case where the electrostatic discharge protection element 221 is configured by a diode will be described below with reference to FIG. 3.

If static electricity is introduced into the input/output pad 210, the electrostatic induction unit 220 induces the static electricity to the power supply line 212 by a forward-biased diode operation of the electrostatic discharge protection element 221 connected to the input/output pad 210.

Meanwhile, the SCR unit 230 includes a first transistor 231a, a second transistor 231b, and a substrate resistor 231c. Specifically, the first transistor 231a is connected between the data input/output line 211 and the ground voltage line 213, and is connected to the second terminal of the coupling capacitor 240 (which is connected to the power supply line 212), and is connected to the ground voltage line 213 and the coupling capacitor 240. The second transistor 231b is connected to the first transistor 231a and the data input/output line 211 of the input/output pad 210. The substrate resistor 231c is connected between a common node of the first transistor 231a and the coupling capacitor 240 and the ground voltage line 213.

The first transistor 231a and the second transistor 231b may be configured with BJTs or MOS transistors, In this case, the use of the BJTs may obtain higher discharge efficiency than the use of the MOS transistors.

Therefore, the SCR configured with only BJTs will be described below with reference to FIG. 3.

The first transistor 231a may be configured with an NPN transistor. An emitter of the first transistor 231a is connected to the ground voltage line 213, and a base of the first transistor 231a is connected to the coupling capacitor 240 at a node 231n.

The first transistor 231a is turned on by a detection voltage generated by the static electricity introduced through the coupling capacitor 240.

Meanwhile, the second transistor 231b may be configured with a PNP transistor. An emitter of the second transistor 231b is connected to the data input/output line 211 of the input/output pad 210, and a base of the second transistor 231b is connected to a collector of the first transistor 231a. A collector of the second transistor 231b is connected to the substrate resistor 231c at the node 231n.

The second transistor 231b discharges the static electricity from the data input/output Line 211 to the ground voltage line 213 when the first transistor 231a is turned on.

The substrate resistor 231c is connected to the base of the first transistor 231a, the collector of the second transistor 231b, and the second terminal of the coupling capacitor 240 at the node 231n,

A voltage drop occurs across the substrate resistor 231c due to the static electricity introduced through the coupling capacitor 240, and the dropped voltage is applied to the first transistor 231a as the detection voltage.

In this case, the substrate resistor 231c belongs to a discharge path of the second transistor 231b when the first transistor 231a and the second transistor 231b perform a discharge operation.

An operation of the electrostatic discharge protection circuit 200 illustrated in FIG. 3 will be described below.

The static electricity introduced to the power supply line 212 by the electrostatic induction unit 220 flows through the coupling capacitor 240 connected to the power supply line 212. AC components passing through the coupling capacitor 240 cause the voltage drop of the substrate resistor 231c, and the first transistor 231a and the second transistor 231b of the SCR unit 230 are sequentially turned on by the voltage applied to the substrate resistor 231c.

The AC components passing through the coupling capacitor 240, the node 231n and the substrate resistor 231c flow to the ground voltage line 213. DC components and residual AC components of the static electricity are discharged from the data input/output line 211 to the ground voltage line 213 through the SCR unit 230 in which the first transistor 231a and the second transistor 231b are turned on.

FIG. 4 is a block diagram of an electrostatic discharge protection circuit 400, in accordance with a second embodiment of the present invention.

Referring to FIG. 4, the present invention may be applied to an electrostatic discharge protection circuit provided with a detection unit and an electrostatic discharge unit.

The electrostatic discharge protection circuit in accordance with the second embodiment of the present invention will be described below in detail.

The electrostatic discharge protection circuit 400 illustrated in FIG. 4 includes an electrostatic induction unit 420, a detection unit 431, and an electrostatic discharge unit 430 at an input/output pad 410.

The electrostatic induction unit 420 operates to induce the static electricity in one direction from a data input/output line 411 to a power supply line 412. To this end, the structure of the electrostatic induction unit 220 illustrated in FIG. 3 may be used herein.

The detection unit 431 is connected to the power supply line 412 and includes a coupling capacitor (not shown). The detection unit 431 is configured to detect the static electricity from the power supply line 412.

The electrostatic discharge unit 430 is connected between the data input/output line 411 of the input/output pad 410 and a ground voltage line 413, and is connected to the detection unit 431.

The electrostatic discharge unit 430 is configured to discharge the static electricity, which is introduced from the input/output pad 410 to the data input/output line 411, toward the ground voltage line 413. The electrostatic discharge unit 430 is driven by an output signal of the detection unit 431.

To this end, the electrostatic discharge unit 430 may be configured using the structure of the first transistor 231a and the second transistor 231b of the SCR unit 230 illustrated in FIG. 3.

Furthermore, the detection unit 431 may include a resistor (not shown) connected to the coupling capacitor (not shown) in order for voltage drop of the static electricity introduced into the data input/output line 411.

In this case, the detection unit 431 may include a coupling capacitor (not shown) with the same structure as the coupling capacitor 240 of FIG. 3, and a resistor (not shown) connected between the coupling capacitor (not shown) and the ground voltage line.

Moreover, the detection unit 431 may be configured so that the coupling capacitor 240 shares the substrate resistor 231c of the electrostatic discharge unit 430.

That is, the substrate resistor 231c may be configured with the resistor (not shown).

In the electrostatic discharge protection circuit 400 of FIG. 4, AC components of the static electricity introduced through the data input/output line 411 flow into the detection unit 431 through the electrostatic induction unit 430 and the power supply line 412. The electrostatic discharge unit 430 is operated by the AC components of the static electricity detected by the detection unit 431. Thus, the static electricity flowing through the data input/output line 411 is discharged to the electrostatic discharge unit 430.

In accordance with the embodiments of the present invention, the

SCR unit is operated so that the static electricity introduced through the input/output pad is made to flow to the power supply line through the electrostatic discharge protection element connected to the input/output pad, and the AC components of the static electricity are made to flow to the ground voltage line through the coupling capacitor connected to the power supply line. Therefore, the electrostatic discharge protection circuit is operable at a low trigger voltage and signal distortion is not caused. Hence, when the electrostatic discharge protection circuit is applied to input/output pads of high-speed semiconductor integrated circuits, the normal operations of the semiconductor integrated circuits are not affected, thereby increasing the stability and reliability of the semiconductor devices.

While the present invention has been described with respect to the specific embodiments, it will be apparent to those skilled in the art that various changes and modifications may be made without departing from the spirit and scope of the application as defined in the following claims.

What is claimed is:

1. An electrostatic discharge protection circuit, comprising:
an electrostatic induction unit connected between a power supply line and a data input/output line of an input/output pad, and configured to induce static electricity introduced through the input/output pad to the power supply line;
a coupling capacitor having a first terminal coupled to the power supply line; and
a silicon controlled rectifier (SCR) unit coupled to a second terminal of the coupling capacitor, the data input/output line and a ground voltage line,
wherein the SCR unit is configured to discharge the static electricity on the data input/output line to the ground voltage.

2. The electrostatic discharge protection circuit of claim 1, wherein the electrostatic induction unit comprises an electrostatic discharge protection element configured to induce the static electricity in one direction.

3. The electrostatic discharge protection circuit of claim 2, wherein the electrostatic discharge protection element comprises any one of a diode, a metal-oxide-semiconductor (MOS) transistor, a bipolar junction transistor (BJT), and an SCR.

4. The electrostatic discharge protection circuit of claim 1, wherein the SCR unit comprises:
a first transistor configured to be turned on by a detection voltage generated by the static electricity introduced through the coupling capacitor;
a substrate resistor configured to cause a voltage drop by the static electricity introduced through the coupling capacitor, a voltage generated by the voltage drop being applied to the first transistor as the detection voltage; and
a second transistor configured to discharge the static electricity from the data input/output line to the ground voltage line when the first transistor is turned on.

5. The electrostatic discharge protection circuit of claim 4, wherein the substrate resistor belongs to a discharge path of the second transistor.

6. The electrostatic discharge protection circuit of claim 4, wherein the first transistor and the second transistor comprise BJTs or MOS transistors.

7. An electrostatic discharge protection circuit, comprising:
an electrostatic induction unit coupled to both a power supply line and a data input/output line of an input/output pad, and configured to induce static electricity introduced through the input/output pad to the power supply line;
a detection unit coupled to the power supply line and comprising a coupling capacitor, the detection unit being configured to detect static electricity of the power supply line; and
an electrostatic discharge unit coupled to the data input/output line, the ground voltage line, and the detection unit,
wherein the electrostatic discharge unit is configured to be driven by an output signal of the detection unit to discharge the static electricity of the data input/output line to the ground voltage line.

8. The electrostatic discharge protection circuit of claim 7, wherein the electrostatic induction unit comprises an electrostatic discharge protection element configured to induce the static electricity in one direction.

9. The electrostatic discharge protection circuit of claim 8, wherein the electrostatic discharge protection element comprises any one of a diode, a MOS transistor, a BJT, and an SCR.

10. The electrostatic discharge protection circuit of claim 7, wherein the electrostatic discharge unit comprises:
a first transistor configured to be turned on by a detection voltage generated by the static electricity introduced through the coupling capacitor; and
a second transistor configured to discharge the static electricity of the data input/output line to the ground voltage line when the first transistor is turned on.

11. The electrostatic discharge protection circuit of claim 10, wherein the first transistor comprises one of a BJT and a MOS transistor.

12. The electrostatic discharge protection circuit of claim 10, wherein the second transistor comprises one of a BJT and a MOS transistor.

13. The electrostatic discharge protection circuit of claim 7, wherein the detection unit comprises:
the coupling capacitor; and
a resistor connected between the ground voltage line and the coupling capacitor.

14. The electrostatic discharge protection circuit of claim 13, wherein the resistor comprises a substrate resistor of the electrostatic discharge unit.
